(19) United States
(12) Patent Application Publication
(10) Pub. No.: US 2018/0176163 A1
(43) Pub. Date: Jun. 21, 2018

(54) AUTOMATIC SUMMARIZATION OF EMAILS AND GENERATION OF SUBJECT LINES

(71) Applicant: INTERNATIONAL BUSINESS MACHINES CORPORATION, Armonk, NY (US)

(72) Inventors: Gregg M. ARQUERO, Poughkeepsie, NY (US); Eli M. DOW, Wappingers Falls, NY (US); Syed F. HOSSAIN, White Plains, NY (US); Joshua A. SCHAEFFER, Poughkeepsie, NY (US); Yunli TANG, Poughkeepsie, NY (US)

(21) Appl. No.: 15/379,867

(22) Filed: Dec. 15, 2016

(51) Int. Cl. H04L 12/58; G06F 17/27

(52) U.S. Cl. CPC H04L 51/063; G06F 17/274

(57) ABSTRACT

Embodiments include techniques for performing automated email summarization and subject line generation. The technique includes determining, by a computing system, that an email exceeds a threshold length, and responsive to determining that the email exceeds the threshold length, executing an email summarization. The technique also includes displaying the email summarization, the email summarization including extracted key sentences and dependent sentences from the email, and determining a tone of the email based on the email summarization. The technique includes generating a subject line based on the email summarization and the tone, and storing, in a database, the tone associated with the email.

### BACKGROUND

The present invention relates to email communication, and more specifically, to automatic summarization of emails and generation of subject lines.

Email communications are commonly used in business and personal settings. Email communications allow the sender to conveniently send digital information including messages, links, attachments, etc. in an expedient and efficient manner to a number of recipients. The length of the email is generally not limited to any short length and can be based on the topic and complexity of information to be disseminated. Lengthy emails may contain unneeded information and distract the reader from the focus of the message. In enterprise environments, the subject line of the email informs the recipient of the relevance and importance of the message to the recipient's business role and responsibility. Given the vast number of emails users exchange daily, the length of emails and associated subject lines should be managed.

### SUMMARY

According to an embodiment, a computer-implemented method for automatic summarization of emails and generation of subject lines is provided. The computer-implemented method includes determining, by a computing system, that an email exceeds a threshold length, and responsive to determining that the email exceeds the threshold length, executing an email summarization. The computer-implemented method also includes displaying the email summarization, the email summarization includes extracted key sentences and dependent sentences from the email, and determining a tone of the email based on the email summarization. The computer-implemented method includes generating a subject line based on the email summarization and the tone, and storing, in a database, the tone associated with the email.

According to another embodiment, a system for automatic summarization of emails and generation of subject lines is provided. The system includes one or more processors, and at least one memory, the memory including instruction that, upon execution by at least one of the one or more processors, cause the system to perform a method for automated email summarization and subject line generation. The method includes determining, by the computing system, that an email exceeds a threshold length, and responsive to determining that the email exceeds the threshold length, executing an email summarization. The computer-implemented method also includes displaying the email summarization, the email summarization includes extracted key sentences and dependent sentences from the email, and determining a tone of the email based on the email summarization. The computer-implemented method includes generating a subject line based on the email summarization and the tone, and storing, in a database, the tone associated with the email.

According to a different embodiment, a computer program product for automatic summarization of emails and generation of subject lines is provided. The computer program product includes a computer readable storage medium having stored thereon program instructions executable by a processor to cause the processor to determine, by a computing system, that an email exceeds a threshold length, and responsive to determining that the email exceeds the threshold length, execute an email summarization. The computer program product further comprises instructions executable to cause the processor to display the email summarization, the email summarization includes extracted key sentences and dependent sentences from the email, and determine a tone of the email based on the email summarization. The computer program product includes instructions executable to cause the processor to generate a subject line based on the email summarization and the tone, and store, in a database, the tone associated with the email.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram illustrating one example of a processing system for practice of the teachings herein;

FIG. 2 and FIG. 3 are flow diagrams illustrating a method for automatic summarization of emails and generation of subject lines is provided; and

FIG. 4 illustrates a graphical user interface in accordance with an embodiment for automatic summarization of emails and generation of subject lines is provided.

### DETAILED DESCRIPTION

In accordance with embodiments of the disclosure, methods, systems and computer program products for automated email summarization and subject line generation is provided.

In an effort to reduce email length, a technique for reducing a composed email to a concise message is provided. This can aid the reader of the email by reducing the amount of information that needs to be reviewed and removes redundant and non-substantive information from the message. As the length and complexity of the email is reduced and the recipient of the email can focus on the purpose of the communication.

An aspect of the technique described herein is to summarize an email when it has passed a threshold length value. Emails that do not exceed the threshold length are unlikely to need summarization. Key sentences will be extracted from the email and the tone of the email can be determined from the email summary. The intended tone can also be changed or improved. Once the email summarization is complete, a subject line can be automatically generated from the summary of the email. The keywords and respective tone are stored in a database for additional analysis.

In one or more embodiments, the technique described herein can be employed as an email plug-in. The email plug-in provides a widget where a user can set and toggle various configurations. The interface for the widget allows for the configuration of different settings such as the summarization feature, setting a threshold length for the number of words in an email, setting a threshold for relevancy threshold for keywords, etc. In an embodiment, if the user does not manually configure a setting a default configuration can be used.

In one or more embodiments, a sentiment analysis is performed to the email communication. In an embodiment, sentiment analysis can be performed automatically. In a different embodiment, sentiment analysis can be toggled on/off by a user in a settings configuration menu. Similarly, a tone analysis can be toggled on/off by a user in the widget or interface. The tone of the message can provide a context for the reader. In addition, after receiving the email summary the user may want to modify the tone of their email based on the feedback of the tone analysis. In another embodiment, the user can modify the tone of the email to ensure that an intended tone is presented.

In one or more embodiments, the tone, keywords, and summary information can be used for workplace analytics. Workplace analytics include determining various metrics for employees such as email topics and tones that each employee is commonly associated with. In one or more embodiments, the overall mood level of individuals can be determined based on the sentiment analysis on the emails transmitted by the respective employees. In an example, if a user frequently receives or sends “angry” emails various actions can be taken to address identified issues associated with the user.

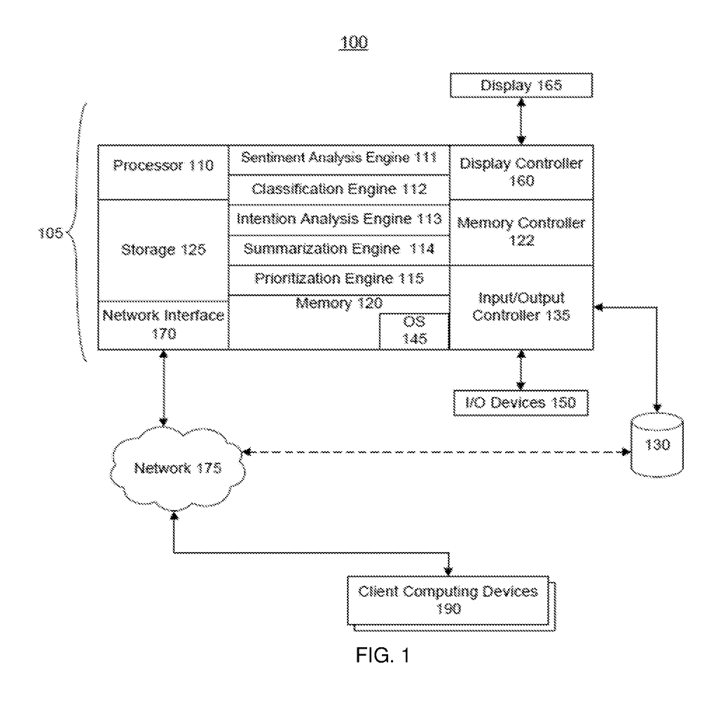

FIG. 1 illustrates a block diagram of a networked computing system 100 for use in an automated email summarization and subject line generation system in performing various techniques described herein. Such techniques may be performed or otherwise implemented via hardware, software (e.g., firmware), or combination thereof. In an exemplary embodiment, the methods described herein are implemented in hardware as the depicted system, which may include the microprocessor of a special or general-purpose digital computer, such as a personal computer, workstation, minicomputer, or mainframe computer. The computing system 100 therefore includes computer 105.

In the illustrated embodiment of FIG. 1, the computer 105 includes a processor 110, a sentiment analysis engine 111, a classification engine 112, an intention analysis engine 113, a prioritization engine 114, a memory 115 coupled to a memory controller 120, internal storage 125, and one or more input and/or output (I/O) devices 150 that are communicatively coupled to the computer 105 via a local input/output controller 135, which in the illustrated embodiment is further communicatively coupled to external storage 130. The input/output controller 135 may include one or more buses or other wired or wireless connections, as is known in the art. The input/output controller 135 may further include additional elements, which are omitted for simplicity, such as controllers, buffers (caches), drivers, repeaters, and receivers, to facilitate communications. Further, the local interface may include address, control, and/or data connections to facilitate appropriate communications among the aforementioned components.

Also in the illustrated embodiment, the processor 110 is a hardware device for executing hardware instructions or software, particularly that stored in memory 115. The processor 110 can be any custom made or commercially available processor, a central processing unit (CPU), an auxiliary processor among several processors associated with the general-purpose computer 105, a semiconductor based microprocessor (in the form of a microchip or chip set), a macroprocessor, or generally any device for executing instructions.

The memory 115 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 115 may incorporate electronic, magnetic, optical, and/or other types of storage media. Note that the memory 115 can have a distributed architecture, where various components are situated remote from one another, but can be accessed by the processor 110.

The instructions in the memory 115 may include one or more separate programs, each of which comprises an ordered listing of executable instructions for implementing logical functions. In the example of FIG. 1, the instructions in the memory 115 include a suitable operating system (OS) 145. The operating system 145 typically controls the execution of other computer programs and may, among other capabilities, provide scheduling, input-output control, file and data management, memory management, and communication control and related services.

In an exemplary embodiment, I/O devices 150 may include, as non-limiting examples, a keyboard, mouse, printer, scanner, microphone, a network interface card (NIC) or modulator/demodulator (for accessing other files, devices, systems, or a network), a radio frequency (RF) or other transceiver, a telephonic interface, a bridge, a router, and other peripherals communicatively coupled to the computer 105 via input/output controller 135. In the depicted embodiment, the computing system 100 further includes a display controller 160 coupled to a display 165, and a network interface 170 communicatively coupled to a network 175. In the depicted embodiment, one or more client computing devices 190 are communicatively coupled to the network 175, such as client computing devices associated with users who interact with the system in order to have the system perform various operations regarding messages directed to those users, or to receive information from the system regarding individual messages or collections thereof.

The network 175 may be an IP-based network for communication between computer 105 and any external server, client and the like via a broadband or other network connection. The network 175 transmits and receives data between the computer 105 and external systems. In an exemplary embodiment, the network 175 may be a managed IP network administered by a service provider. The network 175 may be implemented in a wireless fashion, e.g., using wireless protocols and technologies, such as WiFi, WiMax, etc. The network 175 may also be a packet-switched network such as a local area network, wide area network, metropolitan area network, Internet network, or other similar type of network environment. The network 175 may be a fixed wireless network, a wireless local area network (LAN), a wireless wide area network (WAN) a personal area network (PAN), a virtual private network (VPN), intranet or other suitable network system and includes equipment for receiving and transmitting signals.

In at least some embodiments, the memory 115 may further include a basic input output system (BIOS) (omitted for simplicity). The BIOS is a set of routines that initialize and test hardware at startup, initiate execution of the OS 145, and support the transfer of data among the hardware devices. The BIOS is typically stored in ROM so that the BIOS may be executed when the computer 105 is activated. When the computer 105 is in operation, the processor 110 is configured to execute instructions stored within the memory 115, to communicate data to and from the memory 115, and to generally control operations of the computer 105 pursuant to the instructions.

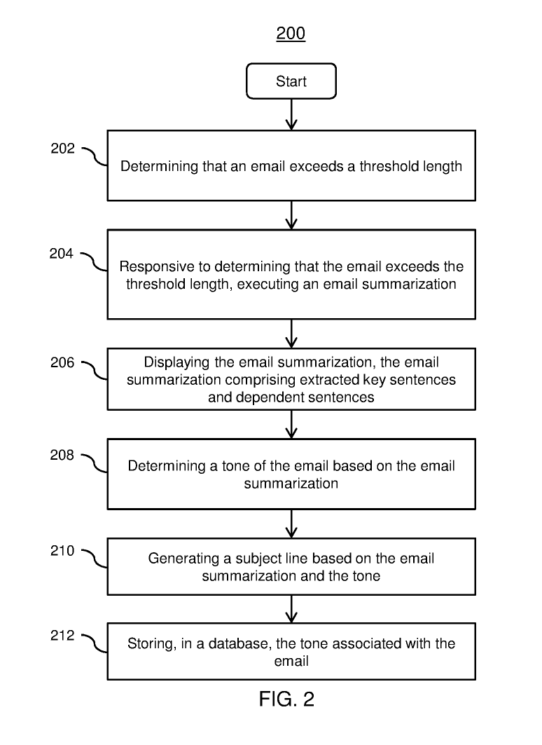

Now referring to FIG. 2, a technique 200 for automatic summarization of emails and generation of subject lines. Block 202 provides determining an email exceeds a threshold length. In one or more embodiments, the message can be an email or a type of text transcript that can be received electronically. In an embodiment, the message can be received by an electronic computing device. In an embodiment, the computing system processes the email as it is being composed by the user.

Block 204 provides responsive to exceeding the threshold length, executing an email summarization. The threshold length of the message can be based on a number of words or a number of lines in the message. In one or more embodiments, the threshold length can be defined by a user or the threshold length can be a default value.

Block 206 displaying the email summarization comprises extracted key sentences and dependent sentences. In an embodiment, a subset of key sentences from the email will be extracted. In one or more embodiments, keywords can be determined by using AlchemyAPI's Keyword Extraction. Keywords with a relevancy score above a certain threshold (threshold can be adjusted in setting 0.0-1.0) will be extracted to form the email summary. In one or more embodiments, sentences that are dependent on key sentences can be added to the summary for readability and comprehension. Including the dependent sentences in the email summary can aid comprehension for the extracted key sentences. For example, the nouns used in the extracted sentences and adjacent sentences in the email can be used to determine whether the adjacent sentences are dependent.

Block 208 provides determining a tone of the email based on the email summarization. In an embodiment, the computing system analyzes the email summarization including the extracted key sentences and dependent sentence and determines the tone of the email. The context of the email summarization can provide an indication of the tone of the email such as cheerful, sad, urgent, formal, informal, comic, sarcastic, etc.

The tone of the email is detected by the computing system and displayed to the user. In an embodiment, the tone of the email can be displayed in the top-right corner of the email. A clickable button that will pop open a window with suggestions on how to improve or change the intended tone of the message to achieve an intended tone of the email and why the given tone was detected. For example, suggested edits may be provided by the system such as changing the word choice used or the addition/deletion of sentences. In an embodiment, the tone can be determined using IBM Watson Service tone analyzer.

Block 210 provides generating a subject line based on the email summarization and the tone of the email. In one or more embodiments, the subject line can be determined to be one of the extracted key sentences of the email summary. In another embodiment, the user can provide a different subject line if unsatisfied by the system generated subject line.

Block 212 provides storing, in a database, the tone associated with the email. In one or more embodiments, the tone and non-stopwords associated with the email are stored in the database. Stop words are words which are filtered out before or after processing of natural language. Stop words refer to the most common words in a language. As a non-limiting example, stopwords include word such as “the,” “at,” “which,” “on,” and the like. Non-stopwords are words that add substance to the sentence. For example, nouns and verbs can be non-stopwords. Non-substantive prepositions and conjunction can be stopwords and therefore would not be stored in the database. The database pairs the tone and keywords to determine the sentiments.

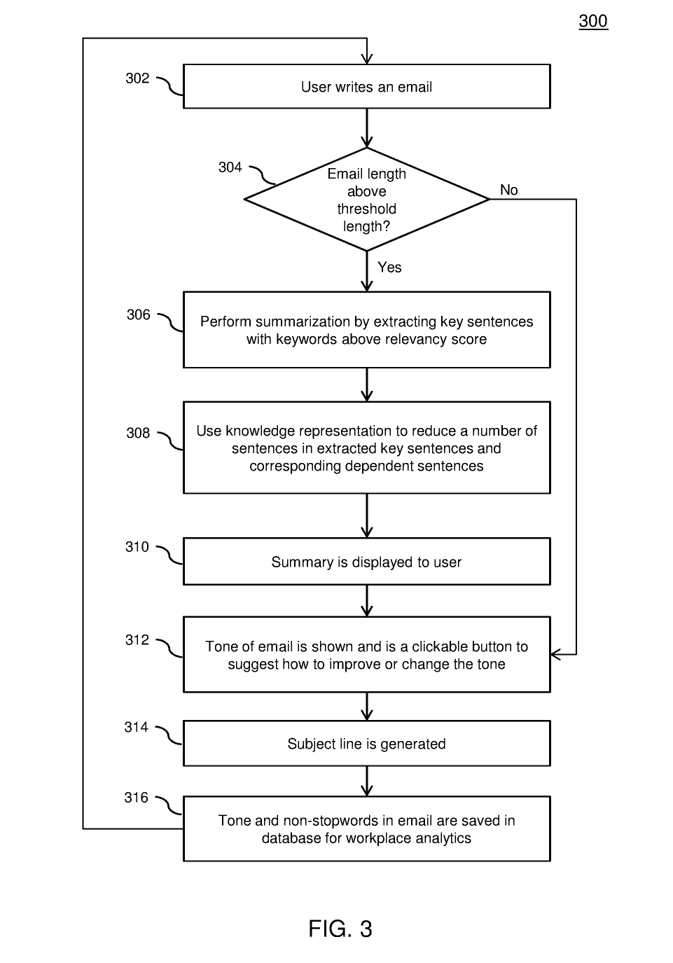

Now referring to FIG. 3, a technique 300 for automatic summarization of emails and generation of subject lines. Block 302 begins as the user writes an email. At block 304, the email length is compared to the threshold length. If the email length exceeds the threshold, the processing proceeds to block 306 to perform the email summarization. The email summarization includes extracting key sentences having keywords that are above a relevancy score.

Block 308 provides using knowledge representation to simplify a subset of sentences in extracted key sentences and corresponding dependent sentences. The knowledge representation includes techniques considers different factors for reducing the email summarization. For example, if extracted key sentences are short and the context cannot be determined, dependent sentences may be added. In another example, the sentence position in a paragraph may provide insight to the topics to be included in the email summarization. The first sentence of a paragraph can indicate the main idea of the paragraph, while the last sentence can indicate a conclusion. In a different example, sentences sharing the same nouns can be determined to be dependent and included in the extracted email summarization or the repetition of the nouns may indicate that the sentence need not be included again in the email summarization. At block 310 the email summarization is provided to the user and proceeds to block 312.

Responsive to not meeting the threshold length, the processing continues to block 312 where the tone of the mail is provided to the user. At block 312 the user is able to execute a function for the system to generate suggestion on how to improve or change the tone of an email to achieve an intended tone. In an embodiment, a user is provided with the system determined tone and if the user is satisfied with the tone the user can confirm the tone of the incorporate the proposed edits and/or suggestions. In one or more embodiments, as the user continues to compose the message, the message is analyzed and the tone is constantly updated and displayed to the user.

Block 314 provides generating a subject line for the email. In one or more embodiments, the subject line of the message is generated based on the extracted key sentences and/or the tone of the email summarization. In an embodiment, the user is given the opportunity to use the generated subject line or the user can provide their own subject line for the email.

Block 316 provides updating a database with the tone and non-stopwords from the message. In an embodiment, the stored tone can represent an overall satisfaction with certain topics. For example, an employee whose email summary is associated with a satisfactory tone can indicate the employee is performing well. Alternatively, an employee whose email summary is associated with complaints and a negative tone can indicate the employee's performance is lacking. The tone and email summary can be organized for each user and can be aggregated for certain topics. Workplace analytics include determining the performance of an employee. After the database is updated, processing continues to block 302 as the user continues to compose the email.

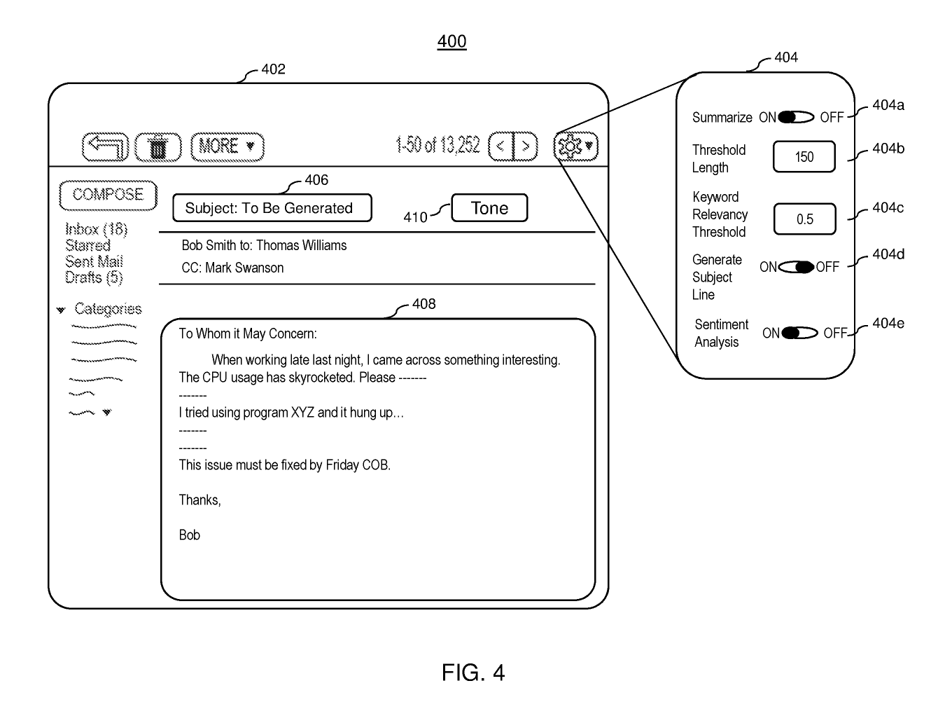

Now referring to FIG. 4 a graphical user interface 400 in accordance with an embodiment for automatic summarization of emails and generation of subject lines is provided. FIG. 4 provides in email message 408 that is being composed.

In one or more embodiments, the summarization feature 404a can be toggled on and off. In an embodiment, the summarization feature 404a may be unavailable for execution in the GUI until the threshold length 404b is reached. For example, the summarize button may remain unclickable until a threshold number of words or lines have been typed. In this example, the threshold length 404b is set to 150 words. After the threshold length 404b is reached and/or after the user has completed his email, the summarization button can be selected and the system generated email summary will be displayed to a user. In an embodiment, the email summarization may be displayed in a separate window. In an embodiment, a user can select a threshold length 404b for summarization where the threshold length is based on a number of typed lines and/or a number of typed words. In another embodiment, the threshold length 404b can be a default threshold length.

In one or more embodiments, a user can select the keyword relevancy threshold 404c for extracting key sentences from the email. In an embodiment, the keyword relevancy threshold score ranges between 0.0 and 1.0, where a score of 1.0 indicates a higher relevance and the score of 0.0 indicates the lowest relevance.

In one or more embodiments, the user can enable the subject line generation 404d feature by toggling the setting in the settings window 404. If the subject line generation 404d feature is enabled, the computing system will generate the subject line 406 in the email 408. In another embodiment, the user can toggle the sentiment analysis 404e for the email. The interface 402 also provides the tone 410 of the email is determined by the computing system is displayed to the user.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that in some embodiments the functionality provided by the routine or routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, it will be appreciated that in other embodiments the operations may be performed in other orders and in other manners. It will also be appreciated that particular data structures discussed above may be structured in different manners, such as by having a single data structure split into multiple data structures or by having multiple data structures consolidated into a single data structure. Similarly, in some embodiments, illustrated data structures may store more or less information than is described, such as when other illustrated data structures instead lack or include such information respectively, or when the amount or types of information that are stored is altered.

The present invention may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for automated email summarization and generation of subject lines, the computer-implemented method comprising:
determining, by a computing system, that an email exceeds a threshold length;
responsive to determining that the email exceeds the threshold length, executing an email summarization;
displaying the email summarization, the email summarization comprising extracted key sentences and dependent sentences from the email;
determining a tone of the email based on the email summarization;
generating a subject line based on the email summarization and the tone; and
storing, in a database, the tone associated with the email.

2. The computer-implemented method of claim 1, wherein executing the email summarization extracts key sentences having keywords above a configurable relevancy score.

3. The computer-implemented method of claim 1, further comprising modifying the tone of the email to achieve an intended tone based on recommended edits to the email.

4. The computer-implemented method of claim 1, wherein the email summarization can be enabled and/or disabled.

5. The computer-implemented method of claim 1, wherein email summarization is unavailable until the threshold length is exceeded.

6. The computer-implemented method of claim 2, wherein the keyword extraction is based on AlchemyAPI Keyword Extraction.

7. The computer-implemented method of claim 1, wherein the subject line is selected from the extracted key sentences from the email summarization.

8. A system for automated email summarization and subject line generation, the system comprising:
one or more processors; and
at least one memory, the memory including instruction that, upon execution by at least one of the one or more processors, cause the system to perform a method for automated email summarization and subject line generation, the method comprising:
determining, by a computing system, that an email exceeds a threshold length;
responsive to determining that the email exceeds the threshold length, executing an email summarization;
displaying the email summarization, the email summarization comprising extracted key sentences and dependent sentences from the email;
determining a tone of the email based on the email summarization;
generating a subject line based on the email summarization and the tone; and
storing, in a database, the tone associated with the email.

9. The system of claim 8, wherein executing the email summarization extracts key sentences having keywords above a configurable relevancy score.

10. The system of claim 8, further comprising modifying the tone of the email to achieve an intended tone based on recommended edits to the email.

11. The system of claim 8, wherein the email summarization can be enabled and/or disabled.

12. The system of claim 8, wherein email summarization is unavailable until the threshold length is exceeded.

13. The system of claim 9, wherein the keyword extraction is based on AlchemyAPl Keyword Extraction.

14. The system of claim 8, wherein the subject line is selected from the extracted key sentences from the email summarization.

15. A computer program product for automated email summarization, the computer program product comprising:
a computer readable storage medium having stored thereon program instructions executable by a processor to cause the processor to:
a processor configured to:
determine, by a computing system, that an email exceeds a threshold length;
responsive to determining that the email exceeds the threshold length, execute an email summarization;
display the email summarization, the email summarization comprising extracted key sentences and dependent sentences from the email;
determine a tone of the email based on the email summarization;
generate a subject line based on the email summarization and the tone; and
store, in a database, the tone associated with the email.

16. The computer readable storage medium of claim 15, wherein the executing the email summarization extracts key sentences having keywords above a configurable relevancy score.

17. The computer readable storage medium of claim 15, wherein the program instructions are further executable by a processor to cause the processor to modify the tone of the email to achieve an intended tone based on recommended edits to the email.

19. The computer readable storage medium of claim 15, wherein email summarization is unavailable until the threshold length is exceeded.

20. The computer readable storage medium of claim 16, wherein the keyword extraction is based on AlchemyAPI Keyword Extraction.
